(19) United States
(12) Patent Application Publication
(10) Pub. No.: US 2008/0313805 A1
(43) Pub. Date: Dec. 25, 2008

(54) Guiding device

(76) Inventor: YU-WEN CHENG, Taichung City (TW)

Correspondence Address: PRO-TECHTOR INTERNATIONAL SERVICES, 20775 NORADA CT., SARATOGA, CA, 95070, US

(21) Appl. No.: 11/821,178

(22) Filed: Jun. 22, 2007

(51) Int. Cl. A61G 1/003

(52) U.S. Cl. 5/81.1 HS

(57) ABSTRACT

A guiding device, comprises a plurality of straight rails, a plurality of curved rails, and at least one elevator rail assembly, connecting straight rails or curved rails, each of the rails having a groove and two opposite sides which form protective plates, wherein the grooves of the straight rails, the curved rails and the at least one elevator rail assembly are combined to form a single groove, providing a track for moving a patient.

### FIELD OF THE INVENTION

The present invention relates to a guiding device, particularly to a guiding device with rails for assisting movements of a sick or handicapped person.

### BACKGROUND OF THE INVENTION

Elderly persons and those who are handicapped at lower body parts have difficulties to move between various rooms of an apartment. While for such a patient a wheelchair is of great help therefor, it is still necessary to assist the patient to move onto and away from the wheelchair, which is difficult and requires much physical strength.

For solving above problem, cranes have been designed on which patients are suspended and moved. However, such cranes need steel scaffolding, are expensive and are practically impossible to move. Furthermore, being transported by cranes deprives patients of dignity.

### SUMMARY OF THE INVENTION

It is an object of the present invention to provide a guiding device for conveniently moving a patient.

Another object of the present invention is to provide a guiding device which is easily assembled and disassembled.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic illustration of the guiding device of the present invention.

FIG. 2 is a schematic illustration of connecting parts of the present invention.

FIG. 3 is a schematic illustration of elevator parts of the present invention when disassembled.

FIG. 4 is a schematic illustration of the present invention in the second embodiment.

### DESCRIPTION OF THE PREFERRED EMBODIMENT

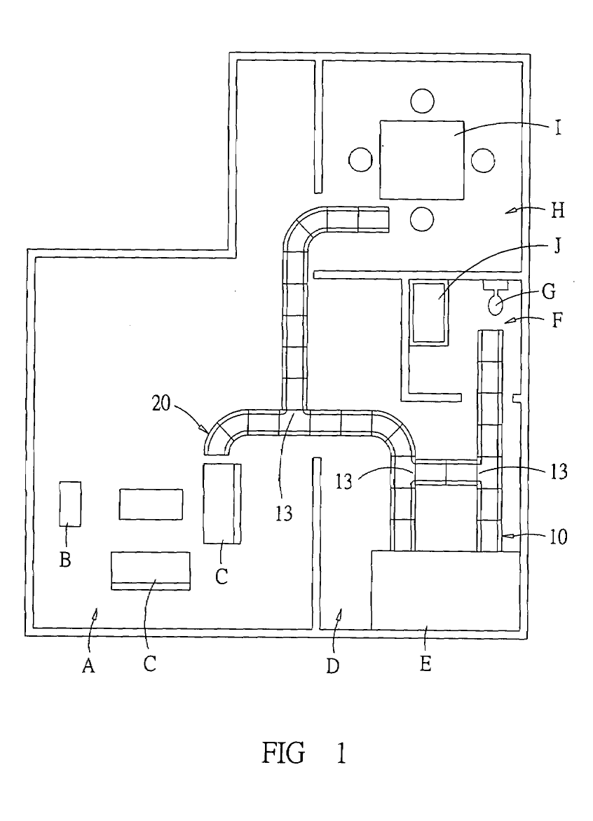

As shown in FIGS. 1-4, the guiding device of the present invention comprises: a plurality of straight rails 10; a plurality of curved rails 20; and a plurality of elevator rail assemblies 30; all of which are provided with grooves. The grooves are combined to form a single, continuing groove along which a patient moves by himself or herself or is pulled using a band and a gliding or roll assembly. The band and the gliding or roll assembly are conventional art and are not further explained. In the following, a detailed description is given.

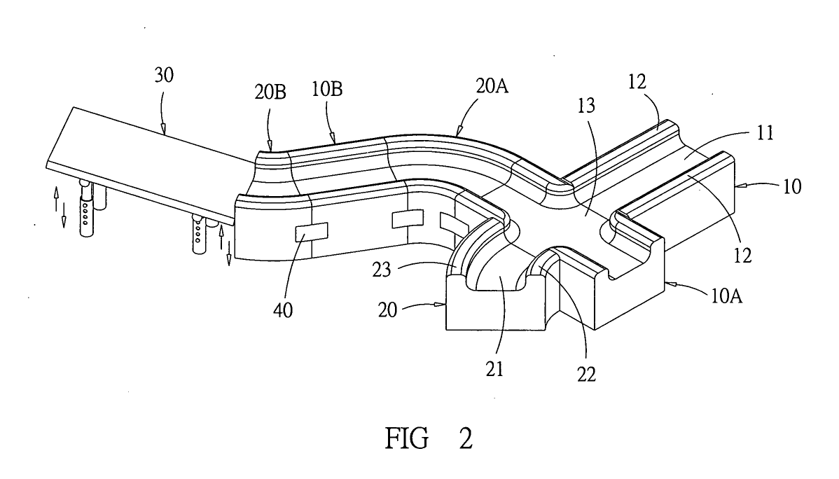

As shown in FIG. 2, each of the straight rails 10 is of rectangular shape, having a groove 11, so that on two opposite sides protective plates 12 are formed. The straight rails 10 are of various lengths, being either long straight rails 10A or short straight rails 10B.

The curved rails 20 are connected with straight rails 10. Each of the curved rails 20 has a groove 21, so that on two opposite sides protective plates 22, 23 are formed. The curved rails 20 are of various lengths, being either long curved rails 20A or short curved rails 20B.

The elevator rail assemblies 30 are connected with straight rails 10 or curved rails 20, facilitating movements between relatively high and relatively low positions of the patient.

Referring again to FIG. 1, common places for the patient are a living room A, watching television B or resting on a sofa C, a bedroom D with a bed E, a bathroom F with a toilet G and a bathtub J, and a dining room H with a dining table I. Those places have various heights, which are connected by the elevator rail assemblies 30.

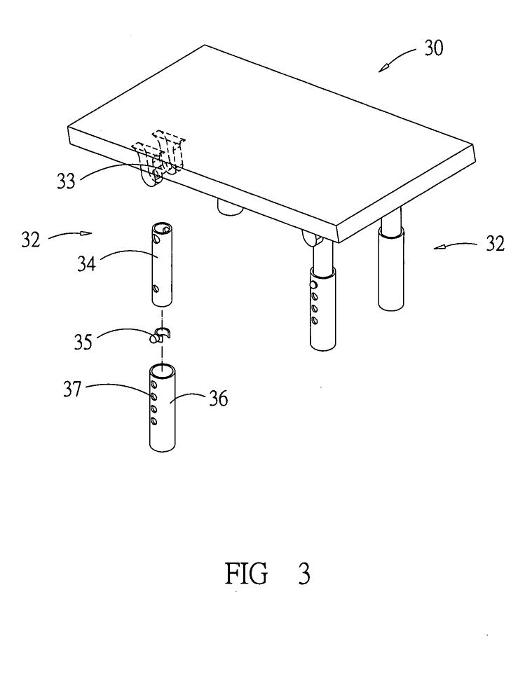

Referring to FIG. 3, each of the elevator rail assemblies 30 has a single top plate 31 for high flexibility of construction.

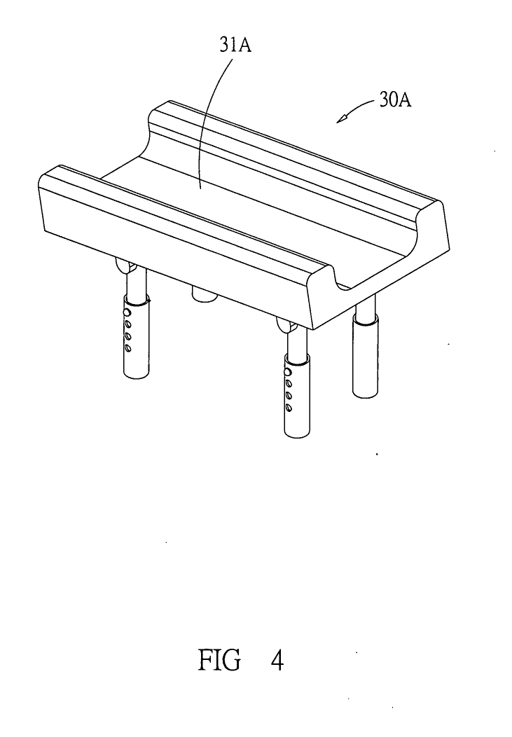

Referring to FIG. 4, each of the elevator rail assemblies 30 has a top groove 31A.

Connecting pieces 40 connect the straight rails 10, the curved rails 20 and the elevator rail assemblies 30 with each other in a variable way according to demand. Thus the guiding device of the present invention is easily assembled and disassembled, and additional passages are easily constructed by adding further rails, as indicated by dotted lines in the Fig. Thereby excessive physical labor by assisting persons or undignified moving of the patient are avoided, while necessary movements of the patient between common places are facilitated.

Referring again to FIG. 3, each of the elevator rail assemblies 30 comprises a base plate 31 and at least lifting devices 32. Each of the lifting devices 32 comprises: an axis 33, mounted on the base plate 31; a connecting rod 34 with an upper end that is connected with the axis 33 and a lower end that is connected with a C-shaped plate spring 35; a tube 36, having several mounting holes 37 on one of which the C-shaped plate spring 35 at the lower end of the connecting rod 34 is mounted to adjust a vertical position and an inclination of the base plate 31. Thereby, the patient is conveniently moved between relatively high and relatively low positions.

The connecting pieces are hook-and-loop fasteners or common fastening elements.

The present invention offers the following advantages:
1. Excessive physical effort for moving a patient with the risk of injuries is avoided.
2. The patient is able to move along rails by himself or herself.
3. The patient maintains is or her dignity while moving.

While a preferred embodiment of the invention has been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A guiding device, comprising:
a plurality of straight rails, having a groove and two opposite sides which form protective plates;
a plurality of curved rails, having a groove and two opposite sides which form protective plates; and
at least one elevator rail assembly, connecting one of said plurality of straight rails or plurality of curved rails with another of said plurality of straight rails or plurality of curved rails, having a groove at a top side and and two opposite sides which form protective plates;
wherein said grooves of said plurality of straight rails, said plurality of curved rails and said at least one elevator rail assembly are combined to form a single groove, providing a track for moving a patient.

2. The guiding device of claim 1, wherein each of said plurality of straight rails is a long straight rail or a short straight rail.

3. The guiding device according to claim 1, wherein each of said plurality of curved rails is a long straight rail or a short curved rail.

4. The guiding device according to claim 1, wherein said top side of said at least one elevator rail assembly is a horizontal plate.

5. The guiding device according to claim 1, wherein said at least one elevator rail assembly comprises a base plate and at least two lifting devices.

6. The guiding device according to claim 5, wherein each of said at least two lifting devices further comprises:
an axis, mounted on said base plate;
a connecting rod with an upper end that is connected with said axis and a lower end that is connected with a C-shaped plate spring; and
a tube, having several mounting holes on one of which said C-shaped plate spring at said lower end of said connecting rod is mounted to adjust a vertical position and an inclination of said base plate;
wherein a vertical position and an inclination of the base plate is adjustable, so that said patient is conveniently moved between relatively high and relatively low positions.
